(19) United States
(12) Patent Application Publication
(10) Pub. No.: US 2010/0257495 A1
(43) Pub. Date: Oct. 7, 2010

(54) 3D-IC Verification Method

(76) Inventor: Chan-Liang Wu, Tainan (TW)

Correspondence Address: STOUT, UXA, BUYAN & MULLINS LLP, 4 VENTURE, SUITE 300, IRVINE, CA, 92618, US

(21) Appl. No.: 12/419,255

(22) Filed: Apr. 6, 2009

(51) Int. Cl. G06F 17/50

(52) U.S. Cl. 716/5

(57) ABSTRACT

A 3D-IC verification method is disclosed. Alignment mark(s), through-silicon via (TSV) and bump structure are defined on dummy layer(s) for each level of the 3D IC, followed by verifying chip(s), the alignment mark, the TSV and the bump structure for each level respectively. The dummy layers of the levels are extracted, and are then integrated. The integrated dummy layers of the 3D IC are then verified vertically.

### BACKGROUND OF THE INVENTION

1. Field of the Invention

The present invention generally relates to integrated circuit (IC) verification, and more particularly to a three-dimensional integrated circuit (3D-IC) verification method adaptable to two-dimensional (2D) electronic design automation (EDA) tools.

2. Description of the Prior Art

As modern electronic systems become more complex, system on chip (SOC) techniques are often used to integrate all electronic components of the electronic system into a single chip. However, it is at times not feasible to construct the electronic system using SOC techniques due to a variety of incompatible process techniques involved.

The three-dimensional integrated circuit (3D-IC) technique, therefore, has shown promise as a technique to construct an integrated circuit with two or more chips integrated vertically and horizontally, even with process-incompatible chips. The 3D IC becomes more popular when the through-silicon via (TSV) technique is applied to electrically connect chips vertically by way of via. FIG. 1A and FIG. 1B show one TSV technique as disclosed by Renesas Technology Corp. In FIG. 1A, the chips 1-4 are stacked by inserting the bump structure 5 of an upper chip into the through-silicon via 6 of an adjacent lower chip. Subsequently, force is exerted on the stacked chips 1-4, resulting in the structure of FIG. 1B. FIG. 2A and FIG. 2B show another TSV technique. In the figures, the chips 11-13 are interconnected by way of TSV 14 and micro bump structure 15. It is noted that, in FIG. 2B, the TSV 14 of adjacent chips 11-13 are not necessarily aligned compared to those in FIG. 2A and FIGS. 1A-1B. FIG. 3 is a schematic diagram illustrating an interconnected 3D IC. In the example, the first (top) level includes chips A and B; the second (middle) level includes chips C, D and E; and the third (bottom) level includes a chip F. These chips may be interconnected using TSV 31 and bump structure 32, and non-adjacent chips (e.g., chip B and chip F) may be directly connected further by a hollow hole 33.

The complexities of modern ICs demand electronic design automation (EDA) tools, such as IC layout editors and IC verification tools (e.g., design rule check (DRC) and layout vs. schematic (LVS)), to design and verify the functions of the ICs before being actually manufactured. As the 3D-IC technique is still new to the industry, no real 3D EDA tools have been developed at present. Conventional (two-dimensional, or 2D) EDA tools may be used, at best, to verify the individual chip or chips of the same level; however, the 2D EDA tools, unfortunately, cannot be used to verify the interconnections among the chips of different levels. The reason that the conventional 2D EDA tools cannot be used in verifying the 3D IC is that the electronic components of all the chips are indiscernible in the resultant drawing layer. Accordingly, the misplacement between the TSV 31 and the bump structure 32 exemplified in FIG. 4, for example, cannot, or at least is difficult to, be detected using the conventional 2D EDA tools.

For the reason that the conventional 2D EDA tools cannot be effectively used to verify the 3D IC or no real 3D-IC EDA tool has yet been developed, a need has arisen to propose a 3D-IC verification method that is capable of integrating with the conventional 2D EDA tools or is utilized alone to verify the 3D IC.

### SUMMARY OF THE INVENTION

In view of the foregoing, it is an object of the present invention to provide a 3D-IC verification method, which may integrate with the conventional 2D EDA tool or work alone to provide capability of verifying 3D ICs. The integrated EDA tool can really verify the 3D ICs without resorting to a costly 3D EDA tool, if even existing.

According to one embodiment of the present invention, alignment mark(s), through-silicon via (TSV) and micro bump structure are defined and depicted on dummy layer(s) for each level of the 3D IC, followed by verifying chip(s), the alignment mark, the TSV and the micro bump structure for each level respectively. The dummy layers of all of the levels are extracted by streaming, and are then integrated according to the alignment marks. The integrated dummy layers of the 3D IC are verified vertically, and the connections between the TSV and the micro bump structure of different levels are then checked.

### BRIEF DESCRIPTION OF THE DRAWINGS

FIG. 1A and FIG. 1B show one TSV technique;

FIG. 2A and FIG. 2B show another TSV technique;

FIG. 3 is a schematic diagram illustrating an interconnected 3D IC;

FIG. 4 shows an exemplary 3D IC, in which the TSV and the bump structure are misplaced;

FIG. 5 shows a flow diagram of a 3D-IC verification method according to one embodiment of the present invention;

FIG. 6A shows an exemplary 3D IC;

FIG. 6B shows the hierarchical cell view of the 3D IC of FIG. 6A;

FIG. 6C shows the flattened cell view of the 3D IC of FIG. 6A;

FIG. 6D shows the stacked levels of the 3D IC of FIG. 6A;

FIG. 7A shows the correctly stacked/overlapped alignment marks;

FIG. 7B shows the incorrectly stacked/overlapped alignment marks;

FIG. 8A shows the extracted dummy layers for each level;

FIG. 8B shows the stacked/overlapped dummy layers of all levels;

FIG. 9 shows misplacement between the TSV and the bump structure;

FIG. 10A shows a detailed flow diagram of the 3D-IC TSV/bump connection check;

FIG. 10B shows an exemplary connection to be checked;

FIG. 10C shows one example illustrating the format of the connection list file; and

FIG. 10D shows another example illustrating the format of the connection list file.

### DETAILED DESCRIPTION OF THE INVENTION

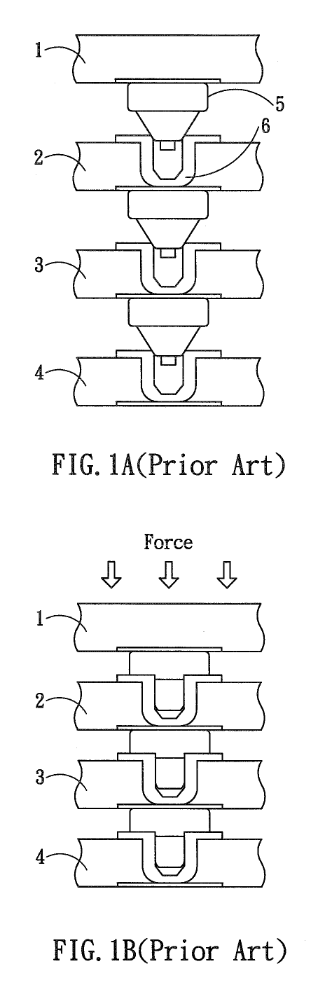

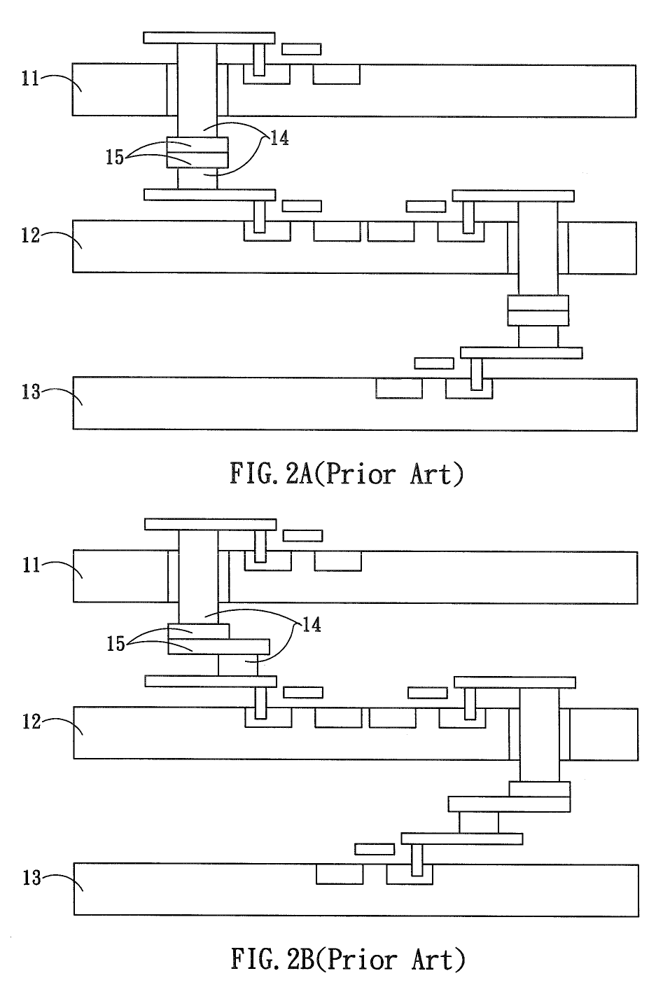

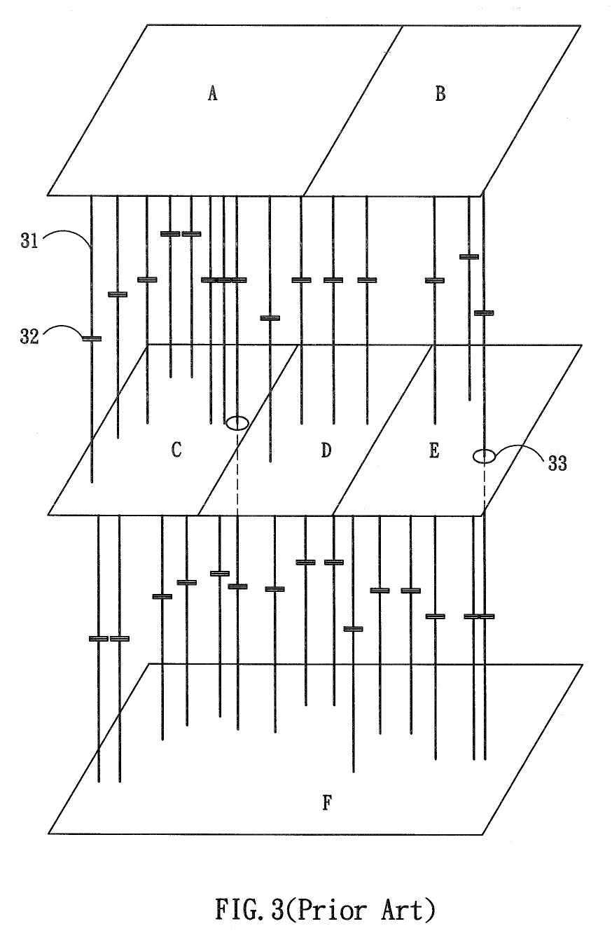

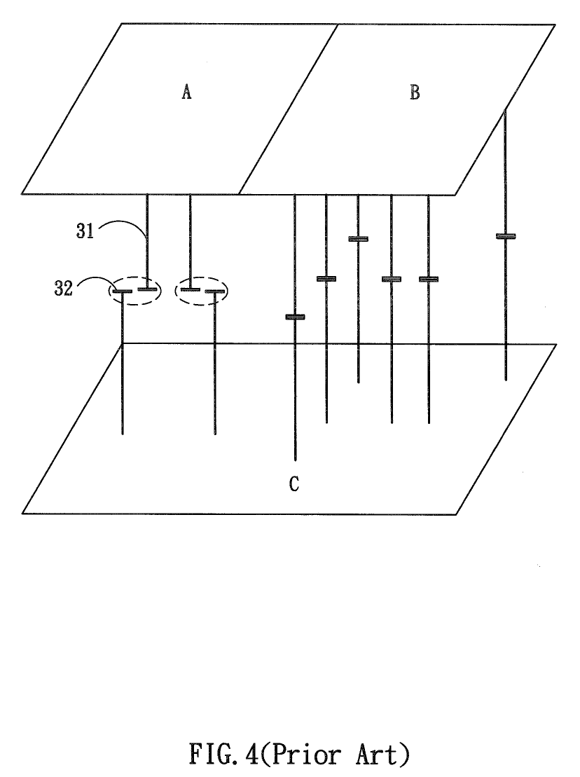

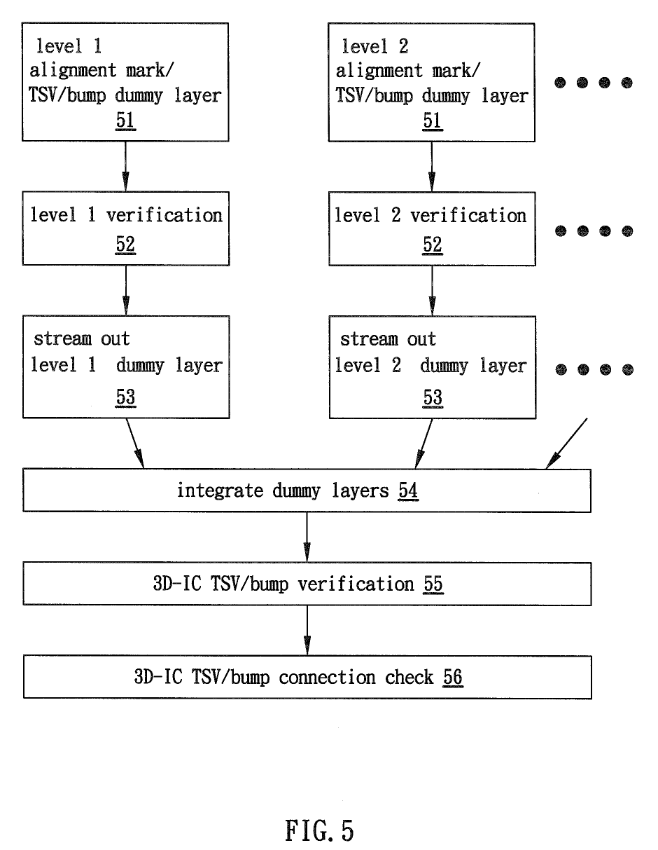

A flow diagram of a 3D-IC (three-dimensional integrated circuit) verification method according to one embodiment of the present invention is shown in FIG. 5, in which the 3D IC includes two or more chips that belong to different levels. The chips are interconnected vertically (while some may be connected horizontally) by way of through-silicon via (TSV) and bump structure (or micro bump structure) such as, but not limited to, the techniques shown in FIGS. 1A-1B and FIGS. 2A-2B.

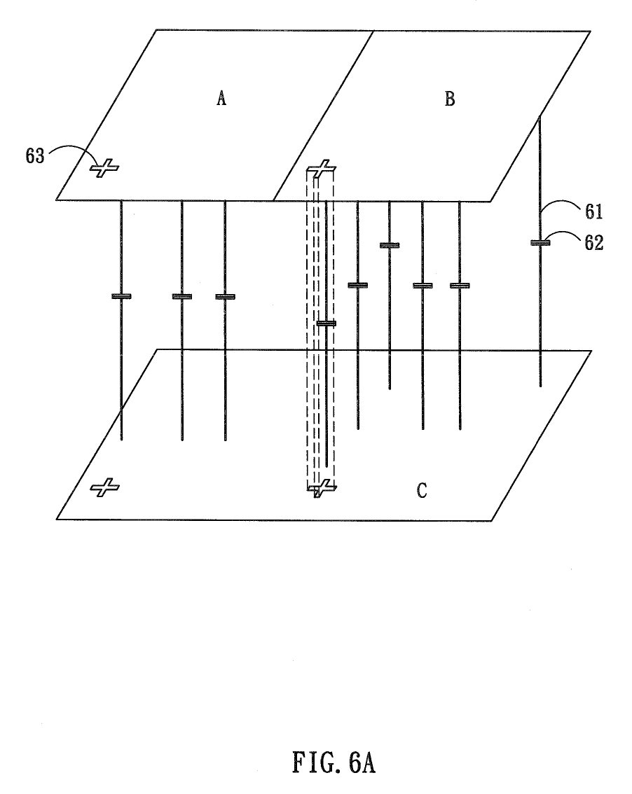

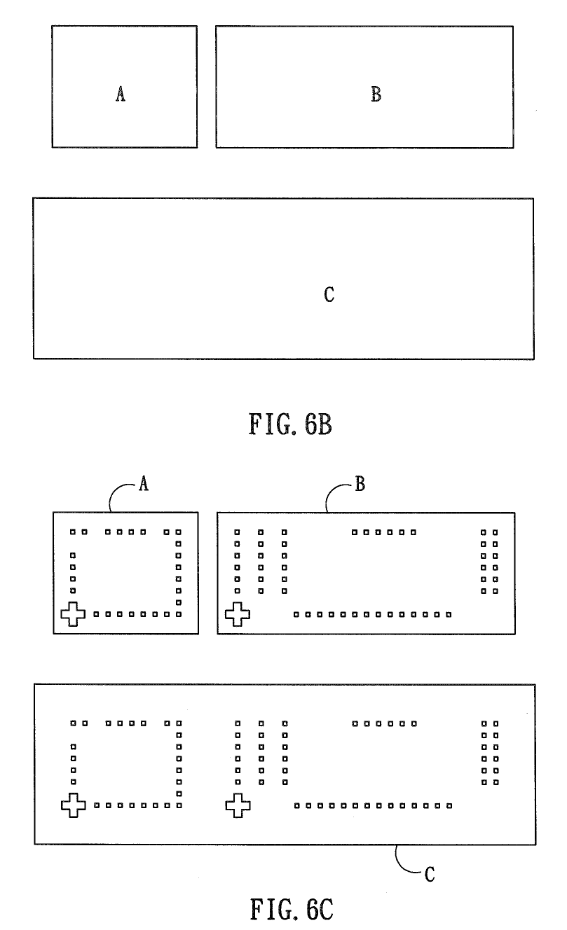

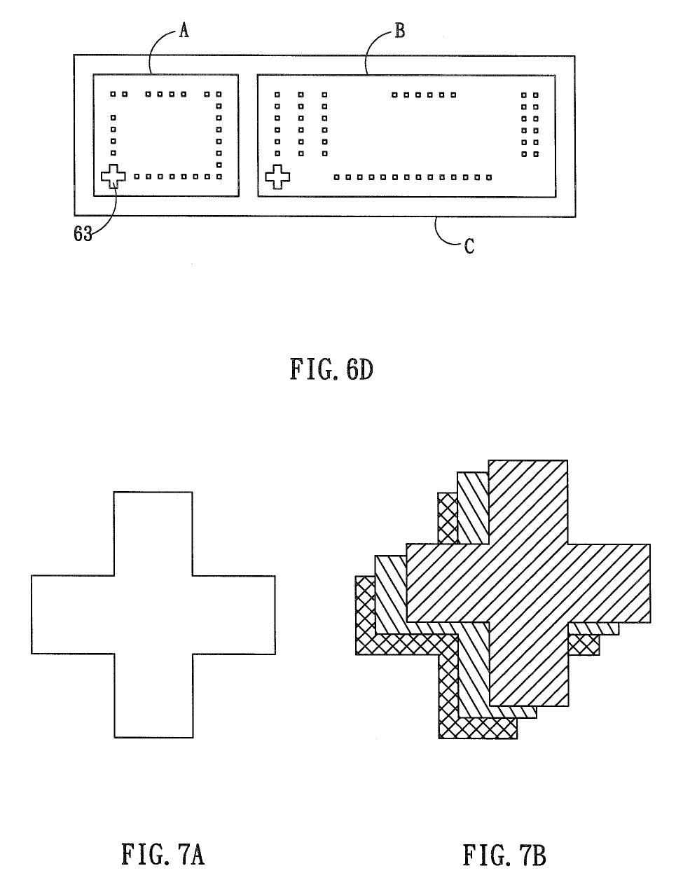

In step 51, at least one dummy layer is provided for each level of the 3D IC, and alignment mark or marks are defined and depicted on the dummy layer. Similarly, TSV and bump structure for each level are also depicted on the at least one dummy layer. In the embodiment, the alignment mark(s) and the TSV of the same level are depicted on the same dummy layer, while the bump structure of the same level are depicted on another dummy layer. As used herein, the term “TSV” means one or more TSVs, and the term “bump structure” means one or more bumps. FIG. 6A shows an exemplary 3D IC, in which the first (top) level includes chips A and B and the second (bottom) level includes chip C. These chips are interconnected using TSV 61 and bump structure 62. Alignment marks 63 are defined on respective levels. FIG. 6B shows the hierarchical cell view of the 3D IC of FIG. 6A, FIG. 6C shows the flattened cell view of the 3D IC of FIG. 6A, and FIG. 6D shows all the levels stacked and aligned by the alignment marks 63.

After the alignment-mark/TSV/bump dummy layers are provided in step 51, each level is then individually subjected to IC verification, such as design rule check (DRC) and layout vs. schematic (LVS) in step 52. The verification for each level may be performed using conventional (two-dimensional, or 2D) electronic design automation (EDA) tools, the associated descriptions of which are omitted herein for brevity.

Subsequently, in step 53, all electronic components except the dummy layers for each level of the 3D IC are streamed out respectively. As used herein, the term “stream out” means that the files of proprietary EDA tools are transformed from library database (with proprietary format) into a standard database file format, such as Graphic Data System II (GDSII, owned by Cadence Design Systems) or Open Artwork System Interchange Standard (OASIS, owned by SEMI). The transformed file (GDSII or OASIS) is a binary file that represents layout information such as geometry shapes and text labels, and provides cell and chip level physical and mask layout data ready for IC fabrication in IC foundries. In the depicted step 53, the dummy layers of each level are respectively extracted by streaming out.

The extracted dummy layers from each level are then integrated or combined in step 54. Specifically, the integration of the dummy layers of all levels is performed primarily according to the alignment marks. FIG. 7A shows the resultant stacked/overlapped alignment marks when the dummy layers are aligned correctly, and FIG. 7B shows an example of the resultant stacked/overlapped alignment marks when the dummy layers are incorrectly aligned.

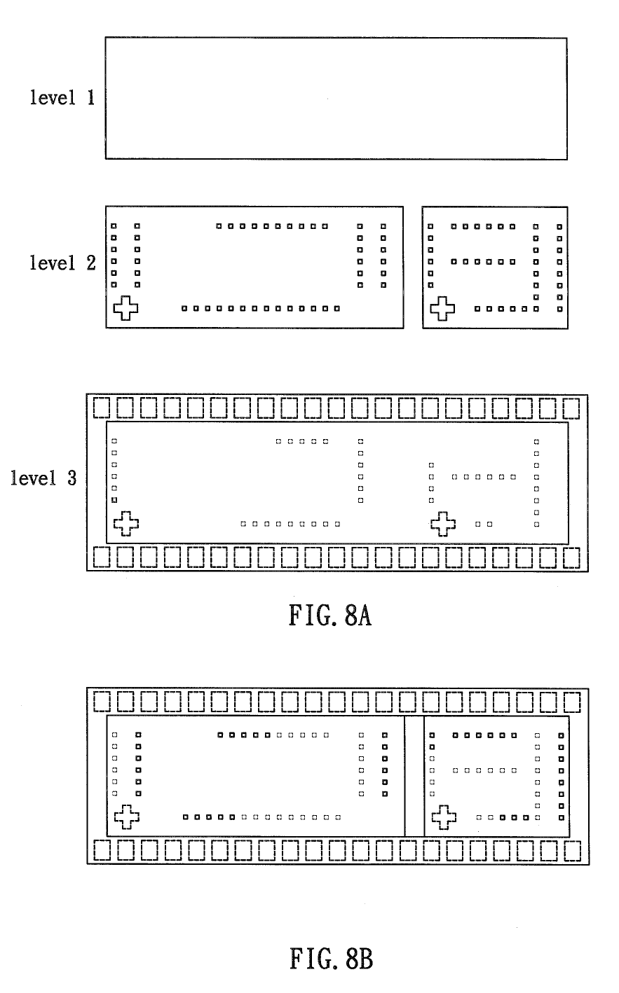

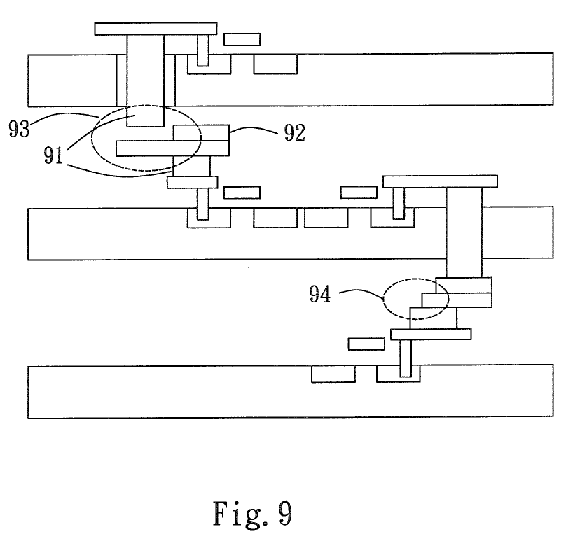

The integrated dummy layers are then subjected to verification, such as design rule check (DRC) in step 55. FIG. 8A shows the extracted dummy layers for each level, and FIG. 8B shows the stacked/overlapped dummy layers of all levels. Through the 3D-IC TSV/bump verification (step 55), the misplacement, if present, between the TSV 91 and the bump structure 92 can be found, such as the misplacements 93 and 94 exemplified in FIG. 9.

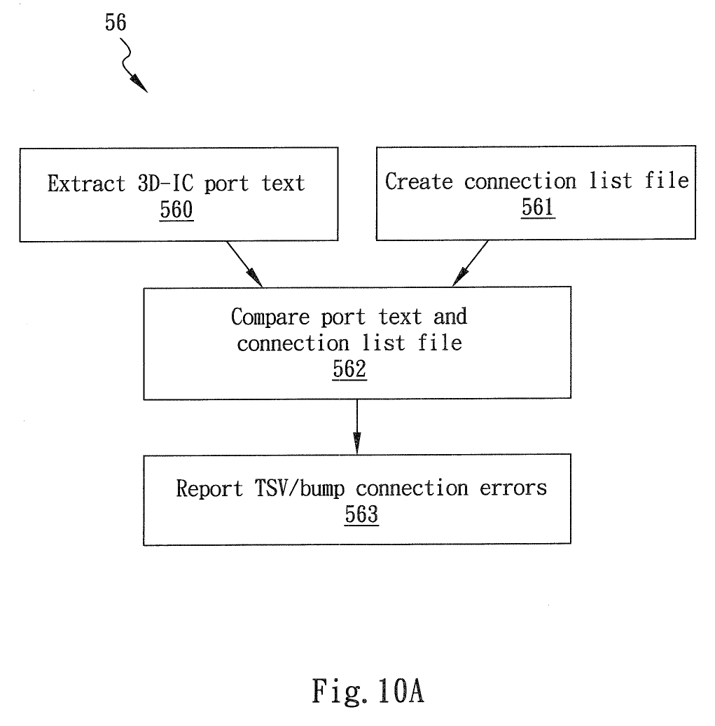

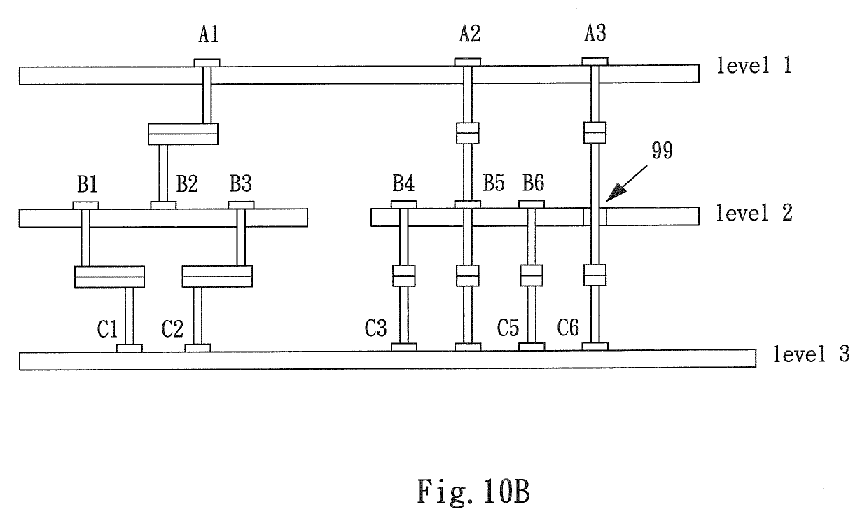

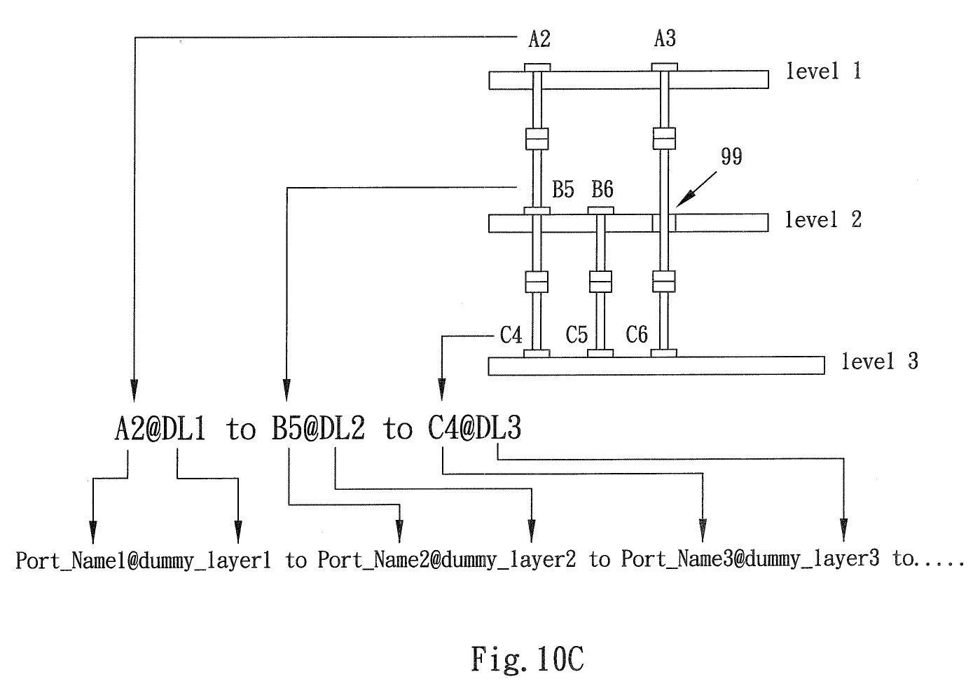

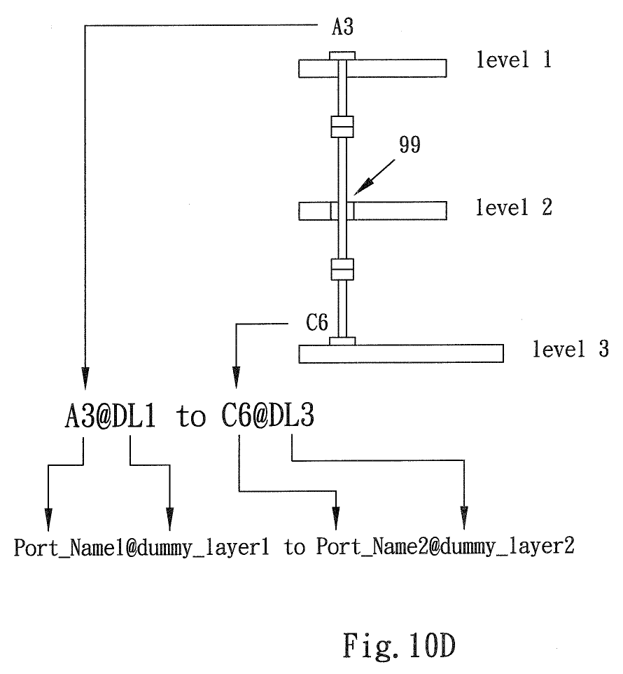

After accomplishing the individual-level check horizontally (step 52) and the integrated TSV/bump check vertically (step 55), the verification of the 3D IC may not even be complete for the reason that the TSV and bump structure of all levels probably connect with each other incorrectly, even when the TSV and bump structure pass the previous checks (such as design rule check and alignment check). In order to prevent and resolve this probable problem, the present embodiment further performs a 3D-IC TSV/bump connection check in step 56. It is appreciated that the TSV and bump structure, or the TSV alone, may be checked in step 56. FIG. 10A shows a detailed flow diagram of step 56, that is, the 3D-IC TSV/bump connection check. FIG. 10B shows an exemplary connection to be checked. In step 560, the 3D-IC port text is extracted. In the extracted port text, the TSV, bump structure or other physical elements are assigned corresponding port names respectively. It is noted that the assignment of the port names and the creation of the associated port text are usually provided in the conventional (2D) EDA tools, and their descriptions are thus omitted for brevity. In the exemplary FIG. 10B, there are three port names A1, A2 and A3 on level 1, six port names B1 through B6 on level 2, and six port names C1 through C6 on level 3.

In step 561, a connection list file is created to declare the connection of the elements (such as the TSV and bump structure) on the respective levels. In the embodiment, the connection list file adapts a format as illustrated in FIG. 10C. In the figure, for example, the port name A2 on the dummy layer (DL1) of the level 1 is denoted as A2@DL1. Similarly, the port name B5 on the dummy layer (DL2) of the level 2 is denoted as B5 DL2, and the port name C4 on the dummy layer (DL3) of the level 3 is denoted as C4@DL3. In FIG. 10C, A2 (level 1) is supposed to be connected to B5 (level 2), which is supposed to be further connected to C4 (level 3). According to the format of the connection list file in the embodiment, the connection among the port names A2, B5 and C4 is thus denoted as A2@DL1 to B5@DL2 to C4@DL3. FIG. 10D shows another example illustrating the format of the connection list file. In this example, the port name A3 on the dummy layer of the level 1 (that is, A3@DL1) is supposed to be directly connected to the port name C6 on the dummy layer of the level 3 (that is, C6@DL3) by way of a through-and-hollow hole 99. According to the format of the connection list file in the embodiment, the connection among the port names A3 and C6 is thus denoted as A3@DL1 to C6@DL3. According to the format of the connection list file as described above, the connection of FIG. 10B may be declared as follows:

### A1@DL1 to B2@DL2

### B1@DL2 to C1@DL3

### B3@DL2 to C2@DL3

### B4@DL2 to C3@DL3

### A2@DL1 to B5@DL2 to C4@DL3

### B6@DL2 to C5@DL3

### A3@DL1 to C6@DL3

Subsequently, in step 562, the 3D-IC port text extracted in step 560 and the connection list file created in step 561 are compared to trace the connection to thereby (e.g., in order to) check connection correctness, for example, by using programming such as Tool Command Language (TCL). According to the result of the comparison performed in step 562, TSV/bump connection errors, if any, may be reported in step 563.

According to the embodiment discussed above, the 3D-IC verification method may be adapted to and integrated with conventional 2D EDA tools, or may be performed alone, for verifying the conformity of 3D ICs with the requirements of function and fabrication. The disclosed embodiment provides a 3D-IC verification method with cost substantially lower than that of a real 3D EDA tool which has not yet even been developed at present.

Although specific embodiments have been illustrated and described, it will be appreciated by those skilled in the art that various modifications may be made without departing from the scope of the present invention, which is intended to be limited solely by the appended claims.

What is claimed is:

1. A three-dimensional integrated circuit (3D-IC) verification method, comprising:
providing at least one dummy layer for each level of a 3D IC, at least one alignment mark, through-silicon via (TSV) and bump structure being defined on the dummy layer;
verifying chip or chips, including the alignment mark, the TSV and the bump structure, for each level respectively;
extracting the dummy layers of the levels;
integrating the extracted dummy layers; and
verifying the integrated dummy layers.

2. The method of claim 1, wherein the alignment mark and the TSV of the same level are defined on the same dummy layer.

3. The method of claim 2, wherein the bump structure is defined on the dummy layer distinct from the dummy layer of the alignment mark and the TSV for the same level.

4. The method of claim 1, wherein the bump structure is micro bump structure.

5. The method of claim 1, wherein design rule check (DRC) or layout vs. schematic (LVS) check is performed in verifying the chip, the alignment mark, the TSV and the bump structure of each level.

6. The method of claim 1, wherein the dummy layers are extracted by streaming out.

7. The method of claim 6, wherein all electronic components except the dummy layers of the 3D IC are streamed out.

8. The method of claim 7, wherein the electronic components that are streamed out are in GDSII or OASIS database file format.

9. The method of claim 1, wherein the extracted dummy layers are integrated according to the alignment marks of the dummy layers.

10. The method of claim 1, wherein design rule check (DRC) is performed in verifying the integrated dummy layers.

11. The method of claim 1, further comprising a step of checking connection between the TSV of different levels.

12. The method of claim 11, wherein the bump structure is further checked in the connection check step.

13. The method of claim 11, wherein the connection check step comprises:
extracting a 3D-IC port text that assigns port names to the TSV;
creating a connection list file that declares connection of the TSV; and
comparing the 3D-IC port text and the connection list file to trace the connection in order to check connection correctness.

14. A three-dimensional integrated circuit (3D-IC) verification method, comprising:
defining and depicting at least one alignment mark, through-silicon via (TSV) and micro bump structure on dummy layers for each level;
verifying chip or chips, including the alignment mark, the TSV and the micro bump structure, for each level respectively;
streaming to extract the dummy layers of all the levels;
integrating the extracted dummy layers according to the alignment marks of the dummy layers;
verifying the integrated dummy layers; and
checking connection between the TSV and the micro bump structure of different levels.

15. The method of claim 14, wherein the alignment mark and the TSV of the same level are defined on the same dummy layer.

16. The method of claim 15, wherein the micro bump structure is defined on the dummy layer distinct from the dummy layer of the alignment mark and the TSV for the same level.

17. The method of claim 14, wherein design rule check (DRC) or layout vs. schematic (LVS) check is performed in verifying the chip, the alignment mark, the TSV and the micro bump structure of each level.

18. The method of claim 14, wherein design rule check (DRC) is performed in verifying the integrated dummy layers.

19. The method of claim 14, wherein the connection check step comprises:
extracting a 3D-IC port text that assigns port names to the TSV and the micro bump structure;
creating a connection list file that declares connection of the TSV and the micro bump structure; and
comparing the 3D-IC port text and the connection list file to trace the connection in order to check connection correctness.
